(19) United States
(12) Patent Application Publication
(10) Pub. No.: US 2005/0007875 A1
(43) Pub. Date: Jan. 13, 2005

(54) Baffle

(76) Inventor: Jurgen Reinemuth, Weinheim (DE)

Correspondence Address: SIMPSON & SIMPSON, PLLC, 5555 MAIN STREET, WILLIAMSVILLE, NY, 14221-5406, US

(21) Appl. No.: 10/840,844

(22) Filed: May 7, 2004

(30) Foreign Application Priority Data
May 9, 2003 (DE) 20307282.0
May 16, 2003 (DE) 20307655.9

(51) Int. Cl. B01F 15/00

(52) U.S. Cl. 366/306

(57) ABSTRACT

A baffle for use in an impeller-type mixer (10), in particular for the chemical and/or pharmaceutical industry, with an underlying vessel (10) that has a floor (70) and with a lid (45) through which an impeller extends into the interior (60) of the container, such that in the container interior there is positioned at least one rod-shaped or flat baffle element (15) that extends from the lid (45) toward the floor (70), such that the baffle element (15) is fixed, in particular clamped, in the region between the underlying vessel (10) and lid (45).

### BACKGROUND OF THE INVENTION

The invention relates to a baffle for use in the container of an impeller-type mixing machine. Such baffles are used to disrupt rotational laminar flow thus increasing mixing action and are commonly used in the chemical and pharmaceutical industries. Such baffles are usually incorporated into an underlying vessel having a floor and covered with a lid through which an impeller extends into the interior of the container such that at least one rod-shaped or flat baffle element that extend from the lid toward the floor.

Baffles are employed in such machines in order to ensure thorough mixing of the materials within the container. This is achieved in that the baffle prevents the medium from moving along with, and at about the same speed as, the impeller in the container. The baffle brings about a conversion from tangential into axial flow.

In many of the known enamelled mixers baffles are installed by attaching them to nozzles on the upper surface of the container floor or on the lid of the container. A disadvantage of this form of attachment is that at least one nozzle is occupied by a baffle and hence can no longer be used as a connection point for processing purposes, e.g. to connect tubes for emptying the container or the like. As an alternative, it has also been proposed to mount flow-impeding strips on the wall of the container, but this is disadvantageous because of the unfavorable blocking of flow behind them. Furthermore, wall-mounted strips are fixedly welded to the container wall and therefore cannot be exchanged if they become damaged.

The objective of the invention is thus to make available a baffle that can be integrated without using nozzles disposed on the upper lid of the container.

### BREIF DESCRIPTION OF THE INVENTION

The objective is achieved by a baffle, for use in a mixer container, in particular for the chemical and pharmaceutical industries, with an underlying vessel that has a floor and with a lid through which an impeller extends into the interior of the container, such that in the interior at least one rod-shaped or flat baffle element is positioned so as to extend from lid to floor and can be or is attached, in particular clamped in place, in the region between underlying vessel and lid.

This feature results in the advantage, which is a central aspect of the invention, that all the nozzles situated on the upper surface of the container floor or the lid are available for use as processing connectors at any time, because when an apparatus in accordance with the invention is employed, these nozzles are no longer needed for mounting baffles as was previously the case. Hence it is possible for the rod-shaped or flat baffle to be manipulated and exchanged independently of the connecting nozzles of the container.

### BRIEF DESCRIPTION OF THE DRAWINGS

FIG. 1 shows a top perspective view of a first embodiment of a baffle in accordance with the invention;

FIG. 2 is a sectional view of a second embodiment of a baffle in accordance with the invention, after it has been installed.

### DETAILED DESCRIPTION OF THE INVENTION

According to a preferred embodiment of the invention, for each baffle there is provided a holder or bracket that extends for example approximately perpendicular, i.e. at an angle of about 85°-95°, to its longitudinal dimension; this holder can either be clamped directly between the upper edge of the underlying vessel and the associated circumferential edge of the lid, or it can be part of an attachment element in the form of a partial or complete ring that extends inward and can be clamped between the upper edge of the underlying vessel and the associated circumferential edge of the lid. This bracket serves for mounting the baffle.

It should be noted that the baffle elements can also extend into the mixing container at an angle. Slanting inward or outward is just as conceivable as “tilting in the tangential direction”.

Preferably when the attachment brackets for the baffle elements have been installed, they tilted are slightly downward, for example by 3° to 5° relative to the horizontal, to allow the medium to flow off.

By means of the above-mentioned bracket or attachment element it is possible to specify a distance separating the baffle element from the attachment element, and hence from the circumferential wall of the mixing container.

The attachment element can advantageously be set onto the upper edge of the underlying vessel, before the vessel is closed with the lid. It is especially preferred for the attachment element to have the shape of a complete ring, because this avoids the possibility of the baffle accidentally falling into the underlying vessel. Furthermore, the full-ring design offers the advantage that the baffle can be securely installed between two planar flanges, which guarantees a good seal.

When the attachment element is designed as a segment of a ring, it can comprise a retaining element, for instance in the form of a hook, to prevent the baffle from toppling over into the underlying vessel.

According to another embodiment of the invention, the baffle element can be attached to the lower surface of the lid or in the upper region of the underlying vessel, in particular by hanging it up or inserting it into position. In this variant sheaths or bearing surfaces or receptacle units are provided, with which either the baffle element itself or components connected thereto, such as a bracket or a hook-shaped attachment element, can become engaged. For example, the inner upper circumferential edge of the underlying vessel can comprise a projection onto which the attachment element can be hung.

It is in accordance with the invention for the baffle element to be fixedly connected to the bracket, for example riveted or screwed thereto or, according to another embodiment of the invention, made integral therewith, in particular by welding or soldering.

In accordance with another advantageous embodiment of the invention, the attachment element itself is constructed as a sealing ring. Preferably the attachment element is so constructed that the container can be closed in a pressure-tight manner. The attachment element is clamped so tightly, as a result of the clamping action between lid and underlying vessel, that the baffle is fixed firmly in position and cannot be tilted. As a means of attaching the lid to the underlying vessel, for example, anchor screws or other suitable locking mechanisms that are commercially available can be chosen.

In one embodiment the baffle, i.e. the ring-shaped attachment element plus the bracket(s) and the actual baffle elements, can be made of a plastic that will depend on the composition of the reaction mixture and preferably will have an inert coating, for example made of PTFE.

Ordinarily, however, it is advantageous to construct the baffle of steel or stainless steel, which can be enamelled if aggressive materials are to be mixed. In the latter case at least the baffle element and/or the bracket is enamelled. The enamelling preferably consists of a coating that is extremely resistant to corrosion, which will protect the baffle element and, where appropriate, also the bracket from corrosive and/or abrasive influences. Depending on requirements, it is also possible for the attachment element itself, on which are disposed at least one, but preferably two, three or more brackets distributed over its circumference and bearing associated rod-shaped or flat baffle elements, to be provided with such a highly corrosion-resistant coating. The particular embodiment in each case will depend primarily on the materials contained in the mixing vessel and their physicochemical properties.

According to another embodiment of the invention the baffle element, the bracket and the attachment element are made in one piece, which provides additional stability because there are no junctions at which individual components might become disconnected.

Alternatively, the baffle can be made integral with the container lid. This embodiment is advantageous in particular for large reaction vessels and hence baffles of correspondingly large dimensions, because the latter can then be lowered onto the reaction or mixing vessel together with the container lid.

According to another embodiment of the invention the baffle can comprise means for monitoring process parameters. These means are advantageously integrated into the baffle element itself or attached to or set onto it. The elements concerned with measurement technology can be attached to or incorporated into one or all of the baffle elements, in particular when the latter are tubular. By this means it is possible, for instance, to measure the temperature at particular points in the reactor container or over the entire reactor volume. This is in particular extremely advantageous because the temperature measurement can be done so simply and directly in the container.

In accordance with the invention the means for detecting the above-mentioned process parameters, in particular when aggressive substances are to be mixed, are embedded in enamel or, preferably, have enamel fused around them. This embodiment is particularly suitable for temperature sensors.

The rod-shaped baffle element can be constructed as a tube, where appropriate as a flattened tube, in either case being made hollow. An alternative, possibly also hollow construction of a substantially flat baffle element has the form of a paddle, spoon or shovel. Preferably the baffle element has a C-shaped or sickle-shaped cross section. It should be emphasized here that in principle all geometries, including three-dimensional ones, are possible in order to optimize the mixing of the vessel contents.

Similarly, the surface configuration of the rod-shaped or flat profile can be chosen almost arbitrarily. On one hand, it can be selected such that the flow around the baffle is as nearly laminar as possible or, on the other hand, it can incorporate holes in order to induce (micro)turbulence.

Furthermore, the baffle element is suitable for conducting substances into and/or out of the container. For this purpose the baffle element is made hollow and comprises openings through which a fluid can flow into the mixing container or be removed from it. Furthermore, in this embodiment both the bracket on which the particular baffle element is disposed and the associated attachment element comprise corresponding inflow or outflow channels that can be connected to external flexible or rigid tubes for conducting liquids.

Preferably the attachment element comprises connecting nozzles for this purpose, as well as for mounting probes and measurement instruments.

Thus, by extremely economical means, the baffle in accordance with the invention can have a dual function, being simultaneously used to control and/or adjust the process parameters. The relevant openings in the baffle element can be closed as required.

Further embodiments of the invention will be evident in the subordinate claims.

The invention is further described with reference to two exemplary embodiments, which are explained in detail with reference to the drawings. It to be understood that the description of the preferred embodiments is for purposes of illustrating and not limiting the invention.

In the following description, the same reference numerals are used for identical parts and parts with identical actions.

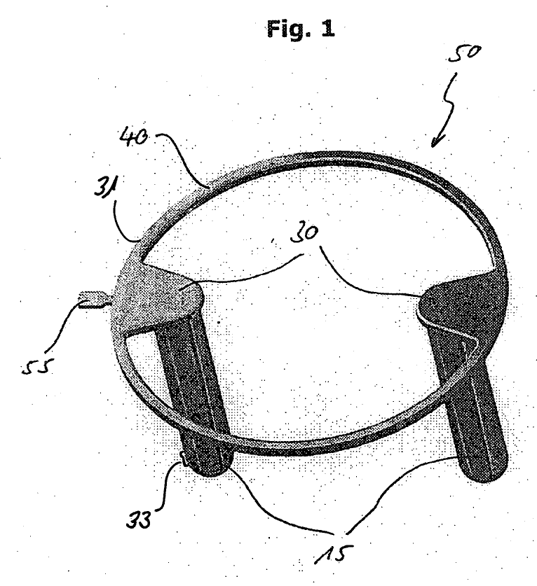

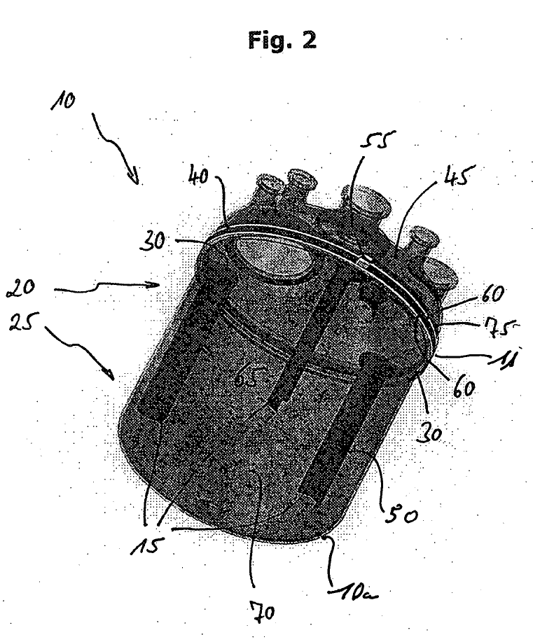

FIG. 1 shows a first embodiment of a baffle 50 in accordance with the invention. The baffle 50 consists of two paddle-like baffle elements 15 that have the profile of a flattened rod and are attached in diametrically opposite positions to brackets 30. Each of the brackets 30 is integrated into a ring 40. On the ring 40 is disposed a connector 55 that projects radially outward and is used as a temperature-measurement site. The ring 40 can be clamped between an upper circumferential edge of an underlying vessel and the circumferential edge of a container lid 45, as seen in FIG. 2, so as to create a leakproof seal. The ring 40 is substantially as wide as the sealing surfaces between underlying vessel and container lid. The two baffle elements 15 are welded to the associated brackets 30. Both the baffle elements 15 and the brackets 30 are provided with an enamel coating 31 that is highly corrosion-resistant. Fused into the paddle-shaped baffle element 15 shown on the left in FIG. 1 is a thermosensor 33.

FIG. 2 shows a partial sectional view in perspective of a second embodiment of a baffle 50 in accordance with the invention, installed in a bipartite mixing or reaction container 10 that consists of a pot-shaped underlying vessel 10a and a lid 45. The baffle 50 comprises a ring-shaped component 40, the diameter of which is matched to the diameter of the upper, circumferential edge 11 of the container 10 and the associated, i.e. facing, circumferential edge 75 of the lid 45. The ring 40 is fixed by clamping between the container lid 45 and mixer container 10, i.e. underlying vessel 10a, by way of two gaskets 60. On the ring 40 as shown in FIG. 2 are three brackets 30, to each of which a baffle element 15 having a C-shaped profile has been welded and completely enamelled. The baffle elements 15 extend within the interior 65 of the container from its upper region 20 into its lower region 25, i.e. toward the floor 70 of the container. No fixation to the floor of the container is necessary. Hence the baffle elements 15 do not occupy any container nozzles, which in particular for containers of small volume has the crucial advantage that these nozzles can be used for other purposes, an improvement over the state of the art. A temperature-measurement site 55 is attached to the ring-shaped attachment element 40.

Another substantial advantage of the baffle 50 described here is that it can be retrofitted at any time in existing bipartite mixing containers, and can be easily exchanged if it should become damaged. Because of the continually flexible installation situation, the baffle 50 can also be repositioned optimally at any time or, depending on the particular design, be supplemented by additional baffle elements 15. Furthermore, the baffle elements 15 in accordance with the invention can be positioned close to the wall, at a sufficient distance from the wall to allow the fluid within the container to flow behind them.

It should be pointed out at this juncture that all the parts described above are claimed as essential to the invention individually and in every combination, in particular the details shown in the drawings. Modifications thereof will be familiar to a person skilled in the art.

1. A baffle for use in conjunction with an impeller-type mixer in a container having an underlying vessel (10) that has a floor (70) and having a lid (45) through which an impeller extends into an interior (60) of the container, such that in the container interior there is positioned at least one baffle element (15) that extends from the lid (45) toward the floor (70); wherein, the baffle element (15) is secured between the underlying vessel (10) and lid (45).

2. The baffle according to claim 1, wherein each baffle element (15) is associated with a bracket(30) that can be clamped between an upper edge (35) of the underlying vessel (10) and an associated circumferential edge (75) of the lid (45).

3. The baffle according to claim 1 wherein each baffle element is associated with a bracket that is part of an attachment element (40) in the form of a partial or complete ring that extends radially inward and can be clamped between upper edge (35) of the underlying vessel (10) and associated circumferential edge (75) of the lid (45).

4. The baffle according to claim 2 wherein the bracket (30), when installed, slants downward at an angle of 3° to 5° with respect to the horizontal.

5. The baffle according to claim 1, wherein the baffle element (15) can be attached to the underside of the lid (45) or in the upper region (20) of the underlying vessel (10).

6. The baffle according to claim 3 wherein the attachment element (40) is constructed as a sealing ring.

7. The baffle according to claim 3 wherein the attachment element (40) comprises, on a side facing the container (10) and a side facing the container lid (45), a structure for the insertion of a sealing means (60).

8. The baffle according to claim 3 wherein the attachment element (40) comprises, on a side facing the container (10) and a side facing the container lid (45), a structure for the attachment of a sealing means (60).

9. The baffle according to claim 2 wherein the baffle element (15) and the bracket (30) are constructed in one piece.

10. The baffle according to one of the claim 3 wherein the baffle element (15), bracket (30) and attachment element (40) are constructed in one piece.

11. The baffle according to claim 1 wherein the baffle is made integral with the container lid (45).

12. The baffle according to claim 2 wherein at least one of the baffle element (15) and the bracket (30) is enamelled.

13. The baffle according to claim 3 wherein at least one of the baffle element (15), the bracket (30) and attachment element (40) is enamelled.

14. The baffle according to claim 1 wherein the baffle comprises a detector for process parameters.

15. The baffle according to claim 14 wherein the detector for process parameters is fused into vitreous enamel.

16. The baffle according to claim 1 wherein at least the baffle element (15) is made hollow for supplying and removing process substances.

17. The baffle according to claim 3 wherein the attachment element comprises connecting nozzles (55), for probes or conduits for supplying and removing substances.

18. The baffle according to claim 1 wherein the surface of the baffle element (15) is provided with knobs, grooves or turbulence-inducing openings.
